(19) United States
(12) Patent Application Publication
(10) Pub. No.: US 2015/0012856 A1
(43) Pub. Date: Jan. 8, 2015

(54) ELECTRONIC DEVICE AND METHOD FOR DISPLAYING USER INTERFACE FOR ONE HANDED OPERATION

(71) Applicants: SHENZHEN FUTAIHONG PRECISION INDUSTRY CO., LTD., Shenzhen (CN); Chiun Mai Communication Systems, Inc., New Taipei (TW)

(72) Inventors: LIANG-FENG XIA, Shenzhen (CN); LI-HAI CHEN, Shenzhen (CN)

(21) Appl. No.: 14/323,111

(22) Filed: Jul. 3, 2014

(30) Foreign Application Priority Data
Jul. 5, 2013 (CN) 2013102818373

(51) Int. Cl. G06F 3/0484; G06F 3/0481

(52) U.S. Cl. CPC G06F 3/04847; G06F 3/04817
USPC 715/765

(57) ABSTRACT

Method of displaying a user interface on an electronic device for one handed operation includes creating a user interface area configured to receive graphic items from the user interface, and displaying the graphic items within the user interface area. The method sets one or more parameters for each graphic item within the user interface area, and controls the electronic device to work in a one-handed operation mode. The method further obtains the set parameters of each graphic item, and adjusts a display screen of the electronic device to display the user interface for one handed operation based on the set parameters of each graphic item.

### FIELD

The present disclosure relates to user interfaces of electronic devices.

### BACKGROUND

Recently, the screens of electronic devices have become larger. The electronic device (e.g., a smart phone) cannot easily be operated with one hand if the electronic device has a screen that is too large.

### BRIEF DESCRIPTION OF THE DRAWINGS

Implementations of the present technology will now be described, by way of example only, with reference to the attached figures.

FIG. 1 is a block diagram of one embodiment of an electronic device including a displaying system.

FIG. 2 is a block diagram of one embodiment of function modules of the displaying system in the electronic device of FIG. 1.

FIG. 3 illustrates a flowchart of one embodiment of a method for displaying a user interface for one handed operation.

FIG. 4 is a diagrammatic view of one embodiment of a user interface including a user interface area.

FIG. 5 is a diagrammatic view of one embodiment of displaying the user interface for a left handed operation.

FIG. 6 is a diagrammatic view of one embodiment of displaying the user interface for a right handed operation.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

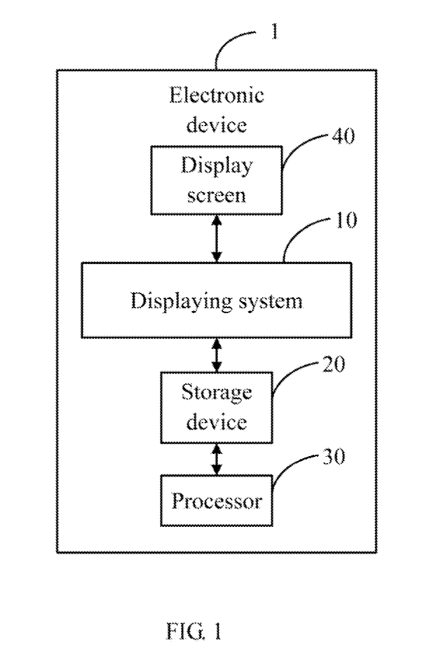

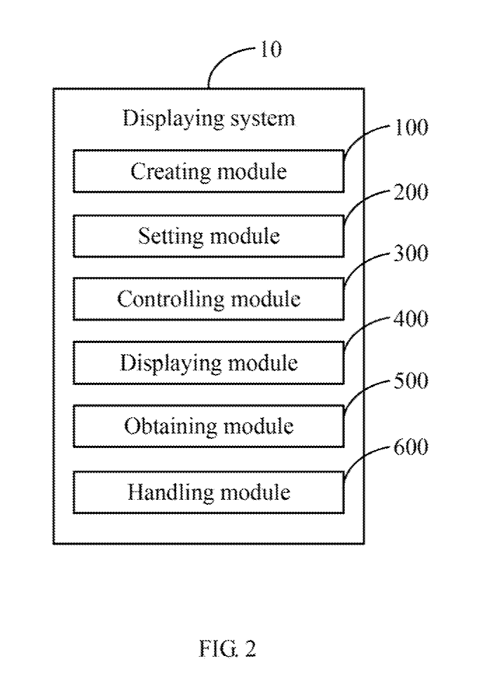

FIG. 1 illustrates a block diagram of one embodiment of an electronic device 1. Depending on the embodiment, the electronic device 1 includes a displaying system 10. The electronic device 1 further includes, but is not limited to, a storage device 20, at least one processor 30, and a display screen 40. The electronic device 1 can be a smart phone, a personal digital assistant (PDA), a tablet personal computer, or other portable electronic device. It should be understood that FIG. 2 illustrates only one example of the electronic device that can include more or fewer components than as illustrated, or have a different configuration of the various components in other embodiments.

The displaying system 10 can display a user interface of the electronic device 1 for one handed operation. The one handed operation enables a user to operate a user interface on the display screen 40 only using one hand (e.g. a left hand or a right hand).

In at least one embodiment, the storage device 20 can include various types of non-transitory computer-readable storage mediums, for example, the storage device 20 can be an internal storage system, such as a flash memory, a random access memory (RAM) for temporary storage of information, and/or a read-only memory (ROM) for permanent storage of information. The storage device 20 can also be an external storage system, such as a hard disk, a storage card, or a data storage medium. The display screen 40 can be a touch screen for inputting computer-readable data by the user. The at least one processor 30 can be a central processing unit (CPU), a microprocessor, or other data processor chip that performs functions of the electronic device 1.

FIG. 2 is a block diagram of one embodiment of function modules of the displaying system 10. In at least one embodiment, the displaying system can include a creating module 100, a setting module 200, a controlling module 300, a displaying module 400, an obtaining module 500, and a handling module 600. The function modules 100-600 can include computerized codes in the form of one or more programs, which are stored in the storage device 20. The at least one processor executes the computerized codes to provide functions of the function modules 100-600.

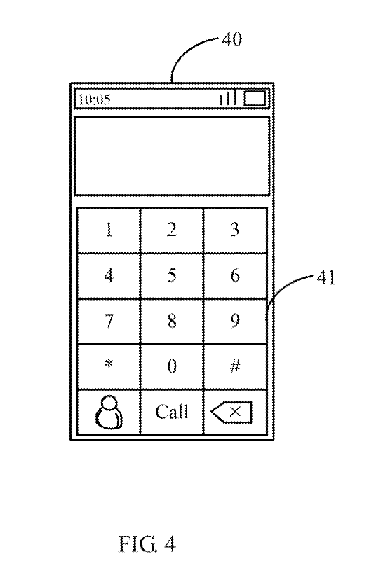

As shown in FIG. 4, the creating module 100 creates a user interface area 41 configured to receive a plurality of graphic items from the user interface of the electronic device 1, and displays the graphic items within the user interface area 41. The graphic items can be one or more virtual buttons or icons displayed on the user interface, and can be operated by one hand of the user. In at least one example, the creating module 100 creates a screen for dialing numbers as the user interface area 41, where buttons of a numeric keypad are the graphic items contained in the user interface area 41.

The setting module 200 sets one or more parameters for each of the graphic items within the user interface area 41. The set parameters can be user-determined or pre-determined by the user. In at least one embodiment, each set parameter includes, but are not limited to, a size of each graphic item, an aspect ratio of each graphic item, a space between two graphic items, a distance between each graphic item and a left edge of the display screen 40, and a distance between each graphic item and a right edge of the display screen 40. For example, in order to magnify an icon, the space between two graphic items can be reduced.

The controlling module 300 controls the electronic device 1 to work in a one-handed operation mode. When the electronic device 1 works in the one-handed operation mode, the electronic device 1 can display the user interface for one handed operation.

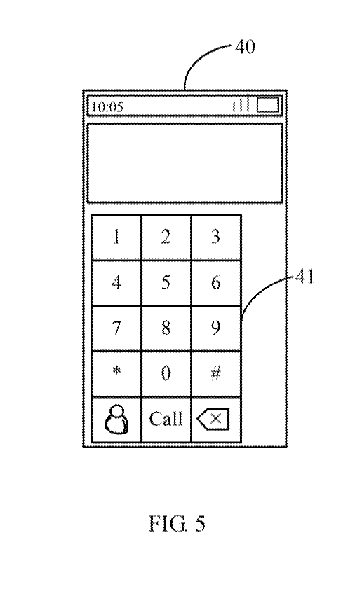

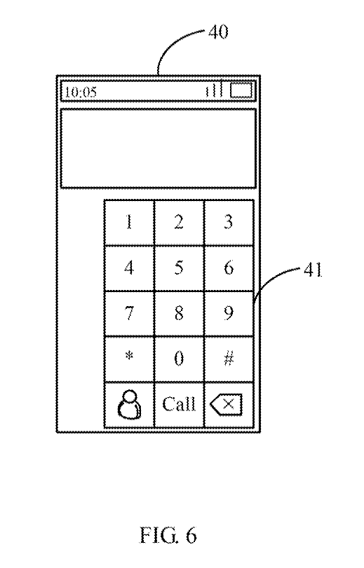

The displaying module 400 obtains the set parameters of the graphic items from the setting module 200, and adjusts the display screen 40 to display the user interface for one handed operation based on the set parameters of the graphic items. For example, the display screen 40 can display a user interface for a left handed operation as shown in FIG. 5, or can display a user interface for a right handed operation as shown in FIG. 6.

The obtaining module 500 sets a plurality of touch operations that can be applied to the user interface area 41, and obtains a touch operation applied to the user interface on the display screen 40. In at least one embodiment, the set touch operations comprise switching the one-handed operation mode of the user interface area 41 from a left handed operation mode to a right handed operation mode, switching the one-handed operation mode of the user interface area 41 from the right handed operation mode to the left handed operation mode, dragging the user interface area 41 to a different position, adjusting a size of the user interface area 41, or selecting a graphic item of the user interface area 41.

In at least one embodiment, an option is displayed on the user interface for switching between one-handed operation modes of the user interface area 41. When the option is selected by the user, the user interface area 41 can be switched from the left handed operation mode to the right handed operation mode, or from the right handed operation mode to the left handed operation mode. In at least one embodiment, the electronic device 1 includes a front-set camera for recognizing gestures of a user. When the electronic device 1 recognizes a “turn left” gesture, the user interface area 41 is switched to the left handed operation mode, and the user interface is displayed for the left handed operation. When the electronic device 1 recognizes a “turn right” gesture, the user interface area 41 is switched to the right handed operation mode, and the user interface is displayed for the right handed operation. In at least one embodiment, the electronic device 1 includes an acceleration sensor to detect physical shaking of the electronic device. When the electronic device 1 is shaken to the left or flung leftward, the user interface area 41 is switched to the left handed operation mode, and the user interface is displayed for the left handed operation. When the electronic device 1 is shaken to the right or flung rightward, the user interface area 41 is switched to the right handed operation mode, and the user interface is displayed for the right handed operation.

In at least one embodiment, the user interface area 41 can be dragged by the user to any position. In at least one embodiment, a size of the user interface area 41 is adjusted by pressing the user interface area 41 for a predetermined time. For example, when the user interface area 41 is pressed for about one second, the size of the user interface area 41 is increased 1.1 times.

The handling module 600 controls the electronic device 1 to display the user interface area 41 on the display screen based on the touch operation applied to the user interface on the display screen. In at least one embodiment, the handling module 600 determines whether the touch operation is applied to the user interface area 41 or to a graphic item of the user interface area 41. When the touch operation is applied to a graphic item (e.g., an icon) of the user interface area 41, the handling module 600 executes a function of the graphic item, and displays an executed function result on the display screen 40. When the touch operation is applied to the user interface area 41, the handling module 600 adjusts the one-handed operation mode, the position, or the size of the user interface area 41 according to the touch operation, and displays the result of the adjustment on the display screen 40. For example, when the user interface area 41 is switched from the left handed operation mode to the right handed operation mode, the user interface area 41 is displayed for the right handed operation, as shown in FIG. 6.

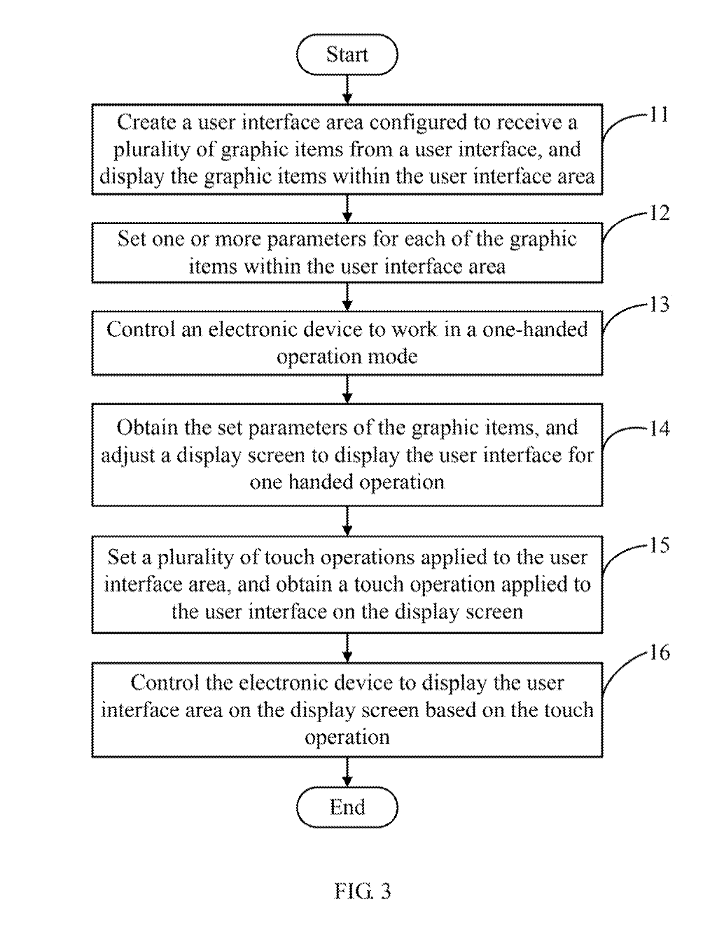

Referring to FIG. 3, a flowchart is presented in accordance with an example embodiment. The example method is provided by way of example, as there are a variety of ways to carry out the method. The method described below can be carried out using the configurations illustrated in FIGS. 1, and 2, for example, and various elements of these figures are referenced in explaining example method. Each block shown in FIG. 3 represents one or more processes, methods, or subroutines, carried out in the exemplary method. Additionally, the illustrated order of blocks is by example only and the order of the blocks can change according to the present disclosure. The exemplary method can begin at block 11. Depending on the embodiment, additional blocks can be added, others removed, and the ordering of the blocks can be changed.

In block 11, a creating module (e.g., the creating module 100 in FIG. 2) creates a user interface area (e.g., the user interface area 41 in FIG. 4) configured to receive a plurality of graphic items from the user interface of an electronic device (e.g., the electronic device 1 in FIG. 1), and displays the graphic items within the user interface area. The graphic items can be one or more virtual buttons or icons displayed on the user interface.

In block 12, a setting module sets one or more parameters for each of the graphic items within the user interface area.

In block 13, a controlling module controls the electronic device to work in a one-handed operation mode.

In block 14, a displaying module obtains the set parameters of the graphic items, and adjusts a display screen (e.g., the display screen 40 in FIG. 1) of the electronic device to display the user interface for one-handed operation based on the set parameters of the graphic items.

In block 15, an obtaining module sets a plurality of touch operations that can be applied to the user interface area, and obtains a touch operation applied to the user interface on the display screen.

In block 16, a handling module controls the electronic device to display the user interface area on the display screen based on the touch operation applied to the user interface on the display screen. In at least one embodiment, the handling module determines whether the touch operation is applied to the user interface area or to a graphic item of the user interface area. When the touch operation is applied to a graphic item (e.g., an icon) of the user interface area, the handling module executes a function of the graphic item, and displays an executed function result on the display screen. When the touch operation is applied to the user interface area, the handling module adjusts the one-handed operation mode, the position, or the size of the user interface area accordingly, and displays the result of the adjustment on the display screen.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A computer-implemented method for displaying a user interface on an electronic device for one handed operation, the method comprising:
creating a user interface area configured to receive a plurality of graphic items from the user interface;
displaying the plurality of graphic items within the user interface area;
setting one or more parameters for each of the plurality of graphic items within the user interface area;
controlling the electronic device to work in a one-handed operation mode;
obtaining the set parameters of each of the plurality of graphic items; and
adjusting a display screen of the electronic device to display the user interface for one handed operation based on the set parameters of each of the plurality of graphic items.

2. The method according to claim 1, further comprising:
setting a plurality of touch operations applied to the user interface area;
obtaining a touch operation applied to the user interface on the display screen; and
controlling the electronic device to display the user interface area on the display screen based on the touch operation applied to the user interface on the display screen.

3. The method according to claim 2, wherein the user interface area is displayed on the display screen by:
determining whether the touch operation is applied to the user interface area or to a graphic item of the user interface area;
executing a function of the graphic item, and displaying an executed function result on the display screen when the touch operation is applied to the graphic item of the user interface area; and
adjusting the one-handed operation mode, a position, or a size of the user interface area according to the touch operation, and displaying the result of the adjustment on the display screen when the touch operation is applied to the user interface area.

4. The method according to claim 2, wherein the touch operation comprises switching the one-handed operation mode of the user interface area from a left handed operation mode to a right handed operation mode, switching the one-handed operation mode of the user interface area from the right handed operation mode to the left handed operation mode, dragging the user interface area to a different position, adjusting a size of the user interface area, and selecting a graphic item of the user interface area.

5. The method according to claim 4, wherein the one-handed operation mode of the user interface area is switched by selecting an option displayed on the display screen, recognizing a turn left or turn right gesture, or by shaking the electronic device to left or right.

6. The method according to claim 1, wherein each set parameter comprises a size of each of the plurality of graphic items, an aspect ratio of each of the plurality of graphic items, a space between two graphic items, a distance between each of the plurality of graphic items and a left edge of the display screen, and a distance between each of the plurality of graphic items and a right edge of the display screen.

7. An electronic device for displaying a user interface for one handed operation, the electronic device comprising:
a display screen;
a processor; and
a storage device that stores one or more programs, when executed by the at least one processor, cause the at least one processor to:
create a user interface area configured to receive a plurality of graphic items from the user interface;
display the plurality of graphic items within the user interface area;
set one or more parameters for each of the plurality of graphic items within the user interface area;
control the electronic device to work in a one-handed operation mode;
obtain the set parameters of each of the plurality of graphic items; and
adjust a display screen of the electronic device to display the user interface for one handed operation based on the set parameters of each of the plurality of graphic items.

8. The electronic device according to claim 7, wherein the one or more programs further cause the at least one processor to:
set a plurality of touch operations applied to the user interface area;
obtain a touch operation applied to the user interface on the display screen; and
control the electronic device to display the user interface area on the display screen based on the touch operation applied to the user interface on the display screen.

9. The electronic device according to claim 8, wherein the user interface area is displayed on the display screen by:
determining whether the touch operation is applied to the user interface area or to a graphic item of the user interface area;
executing a function of the graphic item, and displaying an executed function result on the display screen when the touch operation is applied to the graphic item of the user interface area; and
adjusting the one-handed operation mode, a position, or a size of the user interface area according to the touch operation, and displaying the result of the adjustment on the display screen when the touch operation is applied to the user interface area.

10. The electronic device according to claim 8, wherein the touch operation comprises switching the one-handed operation mode of the user interface area from a left handed operation mode to a right handed operation mode, switching the one-handed operation mode of the user interface area from the right handed operation mode to the left handed operation mode, dragging the user interface area to a different position, adjusting a size of the user interface area, and selecting a graphic item of the user interface area.

11. The electronic device according to claim 10, wherein the one-handed operation mode of the user interface area is switched by selecting an option displayed on the display screen, recognizing a turn left or turn right gesture, or by shaking the electronic device to left or right.

12. The electronic device according to claim 7, wherein each set parameter comprises a size of each of the plurality of graphic items, an aspect ratio of each of the plurality of graphic items, a space between two graphic items, a distance between each of the plurality of graphic items and a left edge of the display screen, and a distance between each of the plurality of graphic items and a right edge of the display screen.

13. A non-transitory storage medium having stored thereon instructions that, when executed by a processor of an electronic device, causes the processor to perform a method for displaying a user interface on the electronic device for one handed operation, wherein the method comprises:
creating a user interface area configured to receive a plurality of graphic items from the user interface;
displaying the plurality of graphic items within the user interface area;
setting one or more parameters for each of the plurality of graphic items within the user interface area;
controlling the electronic device to work in a one-handed operation mode;
obtaining the set parameters of each of the plurality of graphic items; and
adjusting a display screen of the electronic device to display the user interface for one handed operation based on the set parameters of each of the plurality of graphic items.

14. The non-transitory storage medium according to claim 13, wherein the method further comprises:
setting a plurality of touch operations applied to the user interface area;
obtaining a touch operation applied to the user interface on the display screen; and
controlling the electronic device to display the user interface area on the display screen based on the touch operation applied to the user interface on the display screen.

15. The non-transitory storage medium according to claim 14, wherein the user interface area is displayed on the display screen by:
determining whether the touch operation is applied to the user interface area or to a graphic item of the user interface area;
executing a function of the graphic item, and displaying an executed function result on the display screen when the touch operation is applied to the graphic item of the user interface area; and
adjusting the one-handed operation mode, a position, or a size of the user interface area according to the touch operation, and displaying the result of the adjustment on the display screen when the touch operation is applied to the user interface area.

16. The non-transitory storage medium according to claim 14, wherein the touch operation comprises switching the one-handed operation mode of the user interface area from a left handed operation mode to a right handed operation mode, switching the one-handed operation mode of the user interface area from the right handed operation mode to the left handed operation mode, dragging the user interface area to a different position, adjusting a size of the user interface area, and selecting a graphic item of the user interface area.

17. The non-transitory storage medium according to claim 16, wherein the one-handed operation mode of the user interface area is switched by selecting an option displayed on the display screen, recognizing a turn left or turn right gesture, or by shaking the electronic device to left or right.

18. The non-transitory storage medium according to claim 13, wherein each set parameter comprises a size of each of the plurality of graphic items, an aspect ratio of each of the plurality of graphic items, a space between two graphic items, a distance between each of the plurality of graphic items and a left edge of the display screen, and a distance between each of the plurality of graphic items and a right edge of the display screen.
